(19) United States
(12) Patent Application Publication
(10) Pub. No.: US 2012/0174274 A1
(43) Pub. Date: Jul. 12, 2012

(54) ENHANCEMENT OF ARMOR

(75) Inventor: Ashok J. Maliakal, Westfield, NY (US)

(73) Assignee: Lucent Technologies Inc., Murray Hill, NJ (US)

(21) Appl. No.: 11/865,102

(22) Filed: Oct. 1, 2007

(51) Int. Cl. F41H 1/02; B29C 35/08; B29C 47/02; D03D 9/00; B29C 51/12

(52) U.S. Cl. 2/2.5; 442/1; 264/171.13; 264/103; 264/483; 264/271.1; 89/922; 89/915

(57) ABSTRACT

An apparatus comprising a multi-layered armor. The multi-layered armor includes a stack of layers, each layer including a mesh of fibers of first polymer molecules, surfaces of the fibers being functionalized by at least one of hydroxyl, ketone, and amine groups. The multilayered armor also includes second polymer molecules being hydrogen bonded to the fiber surfaces, some of the second polymer molecules having hydroxyl, ketone, amine or carboxylic acid groups. The multilayered armor further includes a composition of third polymer molecules molded over the stack.

### STATEMENT OF GOVERNMENT INTEREST IN THE INVENTION

This invention was made with government support under Picatinny Arsenal Contract No. DAAE 30-03-D-1013. The United States government may have certain rights in the invention.

### TECHNICAL FIELD OF THE INVENTION

The present invention relates to an apparatus comprising armor and a method of making the apparatus.

### BACKGROUND OF THE INVENTION

In certain applications, it is desirable to have light-weight armor. Plastic armor is typically lighter than metal armor. However, plastic armor is not as good as metal armor at withstanding multiple projectile hits. For instance, plastic armor can fracture upon a first impact with a projectile, and the fractured pieces of armor have a reduced ability to protect against subsequent projectile impacts.

### SUMMARY OF THE INVENTION

One embodiment is an apparatus comprising a multi-layered armor. The multi-layered armor includes a stack of layers, each layer including a mesh of fibers of first polymer molecules, surfaces of the fibers being functionalized by at least one of hydroxyl, ketone, and amine groups. The multilayered armor also includes second polymer molecules being hydrogen bonded to the fiber surfaces, some of the second polymer molecules having hydroxyl, ketone, amine or carboxylic acid groups. The multilayered armor further includes a composition of third polymer molecules molded over the stack.

Another embodiment is a method. The method comprises forming a stack of layers of fibers, each fiber including first polymer molecules and second polymer molecules being hydrogen bonded to the first polymer molecules. The method also comprises molding a composition of third polymer molecules over the stack.

### BRIEF DESCRIPTION OF THE DRAWINGS

The invention is best understood from the following detailed description, when read with the accompanying FIGUREs. Various features may not be drawn to scale and may be arbitrarily increased or reduced in size for clarity of discussion. Reference is now made to the following descriptions taken in conjunction with the accompanying drawings, in which:

FIG. 1 illustrates a cross-sectional view of an example apparatus of the disclosure;

FIG. 2 illustrates a plan view of the example apparatus shown in FIG. 1; and

FIG. 3 presents a flow diagram showing selected steps in an example method of manufacture of the disclosure.

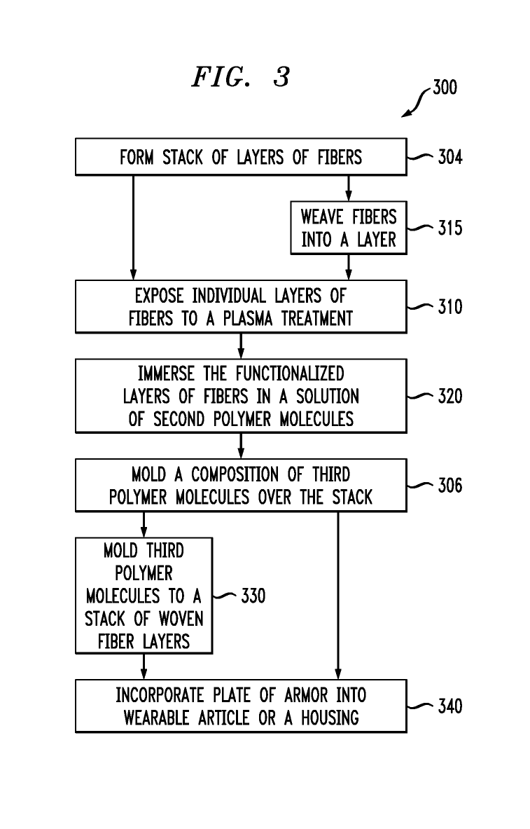

### DETAILED DESCRIPTION

The present disclosure benefits in part from the recognition of factors that can improve an armor's ability to laterally spread the force transferred from an impacting projectile to the article or human being protected. It has been discovered that increasing the strength of the chemical bonds between components of a plastic armor improve the armor's ability to spread an impacting force more broadly throughout the armor.

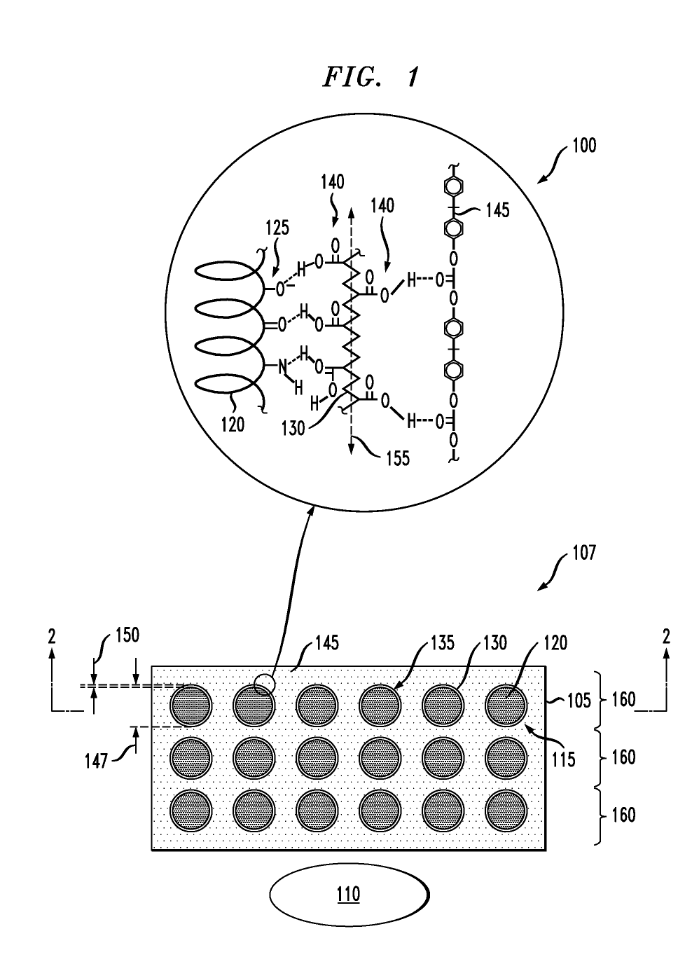

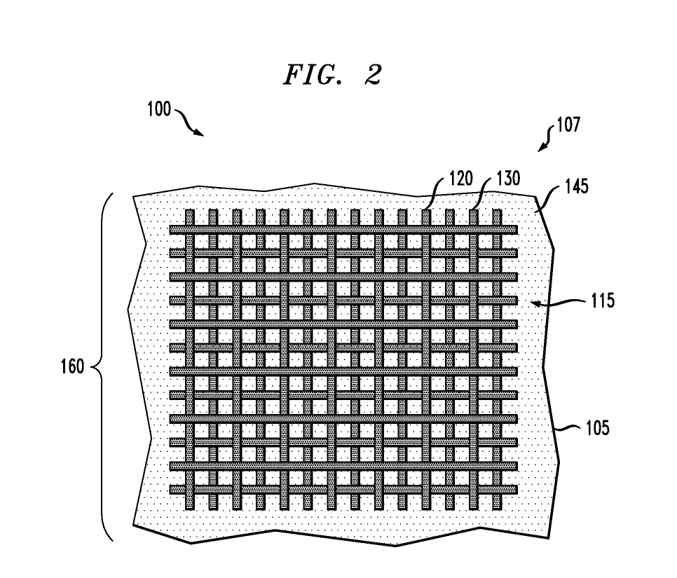

One embodiment is an apparatus. FIG. 1 presents a cross-sectional view of an exemplary apparatus 100. FIG. 2 presents a plan view of the apparatus 100 of FIG. 1 along view line 2-2. The apparatus 100 comprises armor 105. The armor 105 can be incorporated into an article 107 that protects an object 110. In some cases, the apparatus 100 can comprise or be a wearable article 107 such as a bullet-proof vest that protects a living object 110 (e.g., a human). In other cases, the apparatus 100 can comprise a non-wearable article 107 such as a shielding, that protects a mechanical object 110 (e.g., a battery or computer), or, a shielded container (e.g., a bomb disposal container) that holds an explosive object 110.

Armor as used herein, refers to any layered material that is configured to laterally spread a force of a projectile impacting perpendicularly on the layered material. The armor 105 includes fibers 115. As shown in the expanded schematic view also presented in FIG. 1, the fibers 115 includes first polymer molecules 120 functionalized by functional groups 125 that include at least one of hydroxyl (—OH), ketone (R₁R₂C═O) and/or amine (—NH₃) groups. The functional groups 125 can be, or included in, side chains (i.e., substituent groups that are not part of the main polymer chain) of the first polymer molecules 120. The armor 105 also includes second polymer molecules 130 contacting the fiber's 115 surface 135. The second polymer molecules 130 have having hydroxyl, ketone, amine or carboxylic acid groups 140 that hydrogen bond to the functional groups 125 of the first polymer molecules 120. The hydroxyl, ketone, amine or carboxylic acid groups 140 can be, or included in, side chains of the second polymer molecules 130. The armor 105 further includes a third polymer molecules 145 bonded to the second polymer molecules 130. E.g., the second polymer molecules 130 hydroxyl, ketone, amine or carboxylic acid groups 140 can be bonded to the third polymer molecules 145.

The first polymer molecules 120 can form tensile strength fibers 115, e.g., fibers having an axial yield tensile strength equal to about 3 GPa or greater. The first polymer molecules 120 can be drawn or spun into fibers 115 using techniques well known to one skilled in the art. In some embodiments, the fiber 115 has a diameter 147 of about 10 to 12 micrometers. Example first polymer molecules 120 include polyaramids or polyparaphenylene terephthalamides, such as the various well-known grades of KEVLAR® (Dupont Co., Wilmington, Del.) or TWARON® (Teijin Twaron, Arnhem, The Netherlands). Other examples include ultra high molecular weight polyethylenes (e.g., polyethylene having repeating ethylene units of about 100,000 or more), such as DYNEEMA® (Royal DSM N.V. The Netherlands) or SPECTRA® (Honeywell, Morristown N.J.).

The surface 135 of the fibers 115 are functionalized to have the functional groups 125 to which hydroxyl, ketone, amine or carboxylic acid groups 140 of second polymer molecules 130 can subsequently hydrogen bond to. At the surfaces 135 of the fibers 115, some or all of the first polymer molecules 120 are modified to have the functional groups 125 by treating the surface 135 with a plasma having oxygen or nitrogen.

In one example, the functionalized surface 135 of the fiber 115 has first polymer molecules 120 that are a paraphenylene terephthalamide polymer molecules functionalized by a plasma treatment. In such instances, the plasma treatment results in the functional groups 125 being attached to the paraphenylene terephthalamide polymer molecule's phenyl rings. That is, functional groups 125 can be one or more hydroxyl, ketone or amine groups bonded to phenyl rings of the paraphenylene terephthalamide polymer. Or, in another example when the functionalized surface 135 of a fiber 115 has first polymer molecules 120 that are ultra high molecular weight polyethylene polymer molecules that are functionalized by a plasma treatment. The plasma treatment results in the functional groups 125 being introduced into the backbone of the polyethylene polymer molecules.

In some embodiments, such plasma treatments only modify the fibers 115 at their surfaces 135. Indeed, functionalization of the first polymer molecules 120 at non-surface locations may detrimentally weaken the tensile strength of the fibers 115. The use of a plasma treatment to achieve such functionalization is advantageous, because the oxygen or nitrogen plasma treatment can be adjusted to only fuctionalize polymers 120 at the fiber's 115 surface 135 to have the functional groups 125. For instance, such a treatment may produce functional groups 125 on the first polymer molecules 120 to a depth 150 of up to about 10 nm from the fiber's 115 surface 135. In some of these embodiments, the first polymer molecules 120 within such a distance 150 of the fiber's surface 135 have 50 percent or higher concentrations of the functional groups 125 than the same molecules 120 located in deeper regions of the fiber 115.

Providing the first polymer molecules 120 with the functional groups 125 facilitates the hydrogen bonding to the hydroxyl, ketone, amine or carboxylic acid groups 140 of the second polymer molecules 130, and to the third polymer molecules 145. Preferably, the second polymer molecule's 130 hydroxyl, ketone, amine or carboxylic acid groups 140 also are hydrogen bonding groups. The term hydrogen bonding groups refers to chemical groups that are capable of being a hydrogen bond donator (e.g., hydroxyl, OH, or, carboxyl, COOH groups) or a hydrogen bond acceptor (e.g., carbonyl C═O or amine NH₃ groups). To enhance bonding, it is advantageous for the second polymer molecule's 130 hydroxyl, ketone, amine or carboxylic acid groups 140 to include one or both of hydrogen bond donating and accepting groups, and for these groups to be distributed along an entire long axis 155 of each of the second polymer molecules 130.

For instance, in cases where the second polymer molecules 130 are poly(acrylic acid) polymer molecules, the hydroxyl, ketone, amine or carboxylic acid groups 140 are carboxylic acid groups. The carboxylic acid group's 140 OH moiety can provide the hydrogen bond donator and the group's 140 C═O moiety can provide the hydrogen bond acceptor. Other embodiments of the second polymer molecules 130 include poly(vinyl alcohol), poly(acrylamide), poly(ethylene imine) polymer molecules. The second polymer molecules 130 can include combinations of these polymers, or other polymers having similar hydrogen bond donating and accepting groups.

Some embodiments of the second polymer molecules 130 have an average molecular weight ranging from about 10000 to about 100000 gm/mole. In some embodiments, the average molecular weight of the second polymer molecules 130 is less than about 10000 gm/mole. In such cases, however, there may be inadequate numbers of hydroxyl, ketone, amine or carboxylic acid groups 140 to insure good hydrogen bonding between the first polymer molecules 120 and the second polymer molecules 130. In other embodiments, the average molecular weight of the second polymer molecules 130 is greater than about 100000 gm/mole. In such cases, however, such higher molecular weight second polymer molecules 130 may not facilitate the formation of further hydrogen bonds between the second polymer molecules 130 and the first polymer molecules 120, or, between the second polymer molecules 130 and the third polymer molecules 145. In such instances, the higher molecular weight second polymer molecules 130 may add unnecessary mass to the armor 105.

The third polymer molecules 145 can be any polymer molecules (molecular weight of 10000 gm/mole or greater) that are capable of hydrogen bonding to the second polymer molecules 130, and that has a melting point that is less than the melting point of the fibers 115. The presence of the third polymer molecules 145 facilitates the absorption and transfer of an impacting force away from the object 110 of the apparatus 100. In some cases, the fibers 115, the second polymer molecules 130 and the third polymer molecules 145 form one or more layers 160 of the armor 105. In cases where the fibers 115 are formed into a woven layer 160, such as a mesh layer of woven fibers as depicted in FIG. 2, the third polymer molecules 145 are, during application, melted so that they permeate between individual strands of the fibers 115, and then re-solidified.

As shown in FIG. 1, a multi-layered armor 105 can include a stack of layers 160 (e.g., 2 to 20 in some embodiments), each layer 160 including a mesh of fibers 115 of first polymer molecules 120, the second polymer molecules 130, and a composition of the third polymer molecules molded over the stack of layers 160. The surfaces 135 of the fibers 115 are functionalized by at least one of the hydroxyl, ketone, amine and carboxylic acid functional groups 140. The second polymer molecules 130 are hydrogen bonded to the fiber surfaces 135, some of the second polymer molecules 130 having hydroxyl, ketone, amine or carboxylic acid groups 140.

Some preferred embodiments of the third polymer molecules 145 are hydrogen bonded to the hydroxyl, ketone, amine or carboxylic acid groups 140 of the second polymer molecules 130. For instance, consider the example when the third polymer molecules 145 are polycarbonate polymer molecules (e.g., polycarbonate of bisphenol A) and the second polymer molecules 130 are poly(acrylic acid) polymer molecules. In such instances, the OH groups of the carboxylic acid groups 140 can hydrogen bond to carbonate groups of polycarbonate polymer molecules 145. In some cases, the second polymer molecules 130 can be hydrogen bonded to both the first polymer molecules 120 and to the third polymer molecules 145. For instance, the C═O groups of different carboxylic acid groups 140 can be hydrogen bonded to hydroxyl functional groups 125 of polyparaphenylene terephthalamide first polymer molecules 120.

It may be desirable to use polycarbonate as the third polymer molecules 145 because this polymer has carbonate groups available for hydrogen bonding. Additionally, polycarbonate can be readily shaped by melting it and formed into a desired structure using conventional molding methods such as extrusion or thermoforming. Polycarbonate is also corrosion and weather resistant, and has desirable strength and durability properties for armor.

In addition to polycarbonate, however, embodiments of third polymer molecules 145 can include other polycarbonates such as a conventional copolymer of polycarbonate and siloxane copolymer of polycarbonate and siloxane may retain their integrity over a broad temperature range. For example, a copolymer of polycarbonate and siloxane such as LEXAN° EXL9330 (General Electric Company, Pittsfield, Mass.) typically does not undergo a brittle transition until below about −40° C., and do not melt or soften until above about 80° C.

Still other embodiments of the third polymer molecules 145 can include thermoplastic resins having hydrogen bonding groups and similar properties to polycarbonate. Examples of such thermoplastic resins include Poly ethylene terepthalate (PET), polyetheretherketone (PEEK), polyetherimide (PEI), polybenzimidazole. In some embodiments, the third polymer molecules 145 can include thermoset resins. As one skilled in the art understands, a thermoset resin comprises polymer molecules that solidify, or “set,” irreversibly when heated. Example thermoset resins include phenol formaldehyde resin, (e.g., polyoxybenzylmethylenglycolanhydride), polyimides, polyurethane, polyesters, and epoxide polymers.

The method 300 comprises a step 304 of forming a stack of layers of fibers, each fiber including first polymer molecules and second polymer molecules being hydrogen bonded to said first linear polymer molecules. The step 302 also comprises a step 306 of molding a composition of third polymer molecules over the stack.

The step 304 can include a sub-step 310 of exposing a layer of fibers to a conventional oxygen or nitrogen plasma treatment. The first polymer molecules at the surfaces of the fibers are functionalized by the plasma treatment to have at least one of hydroxyl, ketone or amine functional groups.

In some embodiments of the plasma treatment (step 310) is performed using a Reactive Ion Etch (RIE) tool. In particular, a conventional RIE tool, e.g., as normally used for etching or stripping away material from a surface (e.g., a silicon surface), can be used to effectively perform the oxygen or nitrogen plasma treatment of the fiber's surface. In some embodiments, the plasma treatment in step 310 may be performed on polyparaphenylene terephthalamide fibers (e.g., KEVLAR® product numbers 29, 49 and 129, Dupont Co., Wilmington, Del.) using a Technics Micro-RIE tool. The plasma treatment can be adjusted to functionalize the polyparaphenylene terephthalamide fibers to a depth of up to about 10 nanometers from the fiber's surface, i.e., such that deeper portions of the fibers are substantially free of modification. The depth of functionalization of the fibers can be controlled by varying the residence time of the fibers in the presence of the plasma.

For example, in some embodiments, the plasma treatment (step 310) includes introducing a feed gas of pure oxygen into the plasma to generate ionized oxygen or other reactive oxygen atoms in a chamber. Individual layers of the fibers (e.g., a woven layer of the fibers) can be placed in the plasma chamber for a duration of about 10 to 30 seconds, to functionalize the surface of the layer with hydroxyl or ketone groups. In some embodiments, for instance, a layer of fibers made of the first polymer molecules, such as polyparaphenylene terephthalamide polymer molecules, is treated for about 10 to 30 seconds in a plasma generated using a feed gas of about 200 to 400 millitorr of oxygen, using a radiofrequency plasma. In other cases, the plasma treatment can be done at atmospheric pressure. In still other embodiments, a similar plasma treatment can be performed where pure nitrogen replaces oxygen as the feed gas. Such a treatment can be used to introduce amine groups into the first polymer molecules. In other embodiments, a combination of nitrogen and oxygen (e.g., air) feed gases can be used to introduce hydroxyl, ketone, and amine groups into the first polymer molecules.

The step 304 can include a sub-step 315 of weaving the fibers into one or more woven layers (e.g., a mesh layer). It may be preferable to form such layers prior to performing the plasma treatment (step 310) so that plasma-treated fibers with the surface modification will be minimally handled between the time the fibers are functionalized by the plasma treatment and exposed to the second polymer molecules in step 315. In some cases, the step 315 of weaving the one or more woven layers comprises weaving a yarn of fibers of the first polymer molecules into the woven layer.

The step 304 can include a sub-step 320 of immersing the individual layers of the fibers that have been functionalized into a solution containing the second polymer molecules. In some embodiments, for example, individual layers of fibers made of first polymer molecules that were exposed to the plasma treatment of step 310 are immersed in a solution of the second polymer molecules by a conventional dip coating procedure. The second polymer molecules have hydroxyl, ketone, amine or carboxylic acid groups that hydrogen bond to the functionalized first polymer molecules. The immersion enables the dissolved second polymer molecules to come into contact with the functionalized surfaces of the fibers and form hydrogen bonds therewith. Dip coating has the advantage of being scalable to enable handling large amounts of stacks of functionalized woven fiber layers. For instance, the functionalized first polymer molecules of the fibers can be placed into a bath containing an about 10% aqueous solution of poly(acrylic acid) and incubated at ambient pressure and room temperature for about 5 to 15 minutes. After the incubation period, the fibers can be removed from the bath and air-dried at room temperature.

The step 306 can includes a sub-step 330 of molding third polymer molecules over a stack of woven fiber layers to form a molded armor. The fibers of the layers have the functionalized first polymer molecules and the second polymer molecules hydrogen-bonded thereto, formed as described in steps 310 and 320.

In some embodiments, sub-step 330 includes placing the third polymer molecules into a form mold containing the stack of fiber layers, and subjecting the form mold to an elevated temperature and pressure sufficient to melt the third polymer molecules. For example, solid pellets or a powder of the third polymer molecules (e.g., polycarbonate) can be placed into the form mold. The stack of woven layers is made in accordance with above-described steps 310 and 315. The third polymer molecules, and a stack of woven fiber layers are then exposed to a pressure of about 1 to 10 atmospheres and temperature of about 450 to 500° F., for several minutes. Consequently, the second polymer molecules are hydrogen bonded to both the fibers of the layers and to the third polymer molecules. The molding of third polymer molecules is typically in-between and around the individual layers of fibers.

In addition to providing further impact protection as discussed above, the molding step 330 may facilitate in forming the armor into a desired planer or non-planer shape as desired to protect the object of interest. In some cases, an armor having the functionalized first polymer molecules, the second polymer molecules and third polymer molecules can be molded, in step 330, into planar layers (e.g., square or rectangular plates) that are then secured in place around the object to be protected. For instance, a plate of the armor can be incorporated in step 340 into armor in a wearable article or into a housing surrounding a mechanical structure. In other cases, such armor can be molded in step 330 to match the shape of the object being protected. For instance, the armor can be shaped to match parts of the human body or of a vehicle. In such cases the armor itself can thereby be a wearable article.

Although the embodiments have been described in detail, those of ordinary skill in the art should understand that they could make various changes, substitutions and alterations herein without departing from the scope of the invention.

What is claimed is:

1. An apparatus, comprising:
a multi-layered armor, including:
a stack of layers, each layer including a mesh of fibers of first polymer molecules, surfaces of said fibers being functionalized by at least one of hydroxyl, ketone, and amine groups;
second polymer molecules being hydrogen bonded to said fiber surfaces, some of said second polymer molecules having hydroxyl, ketone, amine or carboxylic acid groups; and
a composition of third polymer molecules molded over said stack.

2. The apparatus of claim 1, wherein said first polymer molecules are substantially functionalized to a depth of up to about 10 nm from the surfaces of said fibers.

3. The apparatus of claim 1, wherein said second polymer molecules include one of hydrogen bond donating groups and hydrogen bond accepting groups.

4. The apparatus of claim 1, wherein said second polymer molecules have molecular weights between about 10000 to about 100000 Daltons.

5. The apparatus of claim 1, wherein said first polymer molecules include polyaramid polymer molecules.

6. The apparatus of claim 1, wherein said first polymer molecules include polyparaphenylene terephthalamide polymer molecules.

7. The apparatus of claim 1, wherein said first polymer molecules are polyethylene or functionalized polyethylene polymer molecules.

8. The apparatus of claim 1, wherein said second polymer molecules are poly(acrylic acid) or functionalized poly(acrylic acid) polymer molecules.

9. The apparatus of claim 1, wherein said second polymer molecules are poly(vinyl alcohol) or funtionalized poly(vinyl alcohol) polymer molecules.

10. The apparatus of claim 1, wherein said composition of third polymer molecules permeates between ones of said fibers.

11. The apparatus of claim 10, wherein said composition of third polymer molecules includes at least one of a polycarbonate polymer molecule or a copolymer of polycarbonate and siloxane.

12. The apparatus of claim 10, wherein said each layer is a layer of said fibers.

13. The apparatus of claim 1, wherein said armor is incorporated into a wearable article.

14. A method, comprising:
forming a stack of layers of fibers, each fiber including first polymer molecules and second polymer molecules being hydrogen bonded to said first polymer molecules; and
molding a composition of third polymer molecules over said stack.

15. The method of claim 14, wherein forming said layers of fibers includes weaving said fibers into one or more woven layers.

16. The method of claim 14, wherein forming said layers of fibers includes exposing individual layers of fibers made of said first polymer molecules to a plasma treatment having oxygen or nitrogen feed gases to thereby functionalize said first polymer molecules to have at least one of hydroxyl, ketone or amine groups.

17. The method of claim 16, wherein said plasma treatment includes generating reactive oxygen atoms from a feed gas of pure oxygen and exposing said individual layers to said reactive oxygen atoms for a duration of about 10 to 30 seconds.

18. The method of claim 14, wherein forming said layers of fibers includes immersing said individual layers of fibers made of functionalized said first polymer molecules into a solution containing said second polymer molecules.

19. The method of claim 15, wherein said molding includes placing said third polymer molecules into a form mold containing said stack, and subjecting said form mold to an elevation in temperature and pressure that is sufficient to melt said third polymer.

20. The method of claim 14, further including incorporating said stack into armor in a wearable article or into a housing surrounding a mechanical structure.
